(19) United States
(12) Patent Application Publication
(10) Pub. No.: US 2020/0066464 A1
(43) Pub. Date: Feb. 27, 2020

(54) POWER STORAGE APPARATUS AND METHOD FOR MANUFACTURING POWER STORAGE APPARATUS

(71) Applicant: KABUSHIKI KAISHA TOYOTA JIDOSHOKKI, Kariya-shi, Aichi-ken (JP)

(72) Inventors: Atsushi MINAGATA, Kariya-shi (JP); Masato OGASAWARA, Kariya-shi (JP)

(73) Assignee: KABUSHIKI KAISHA TOYOTA JIDOSHOKKI, Kariya-shi, Aichi-ken (JP)

(21) Appl. No.: 16/487,900

(22) PCT Filed: Feb. 9, 2018
(86) PCT No.: PCT/JP2018/004629

§ 371 Date: Aug. 22, 2019

(30) Foreign Application Priority Data
Feb. 28, 2017 (JP) 2017-036919

(51) Int. Cl. H01G 11/82; H01M 10/0585; H01M 10/04; H01M 2/04; H01M 2/18; H01M 10/0525

(52) U.S. Cl. CPC H01G 11/82; H01M 10/0585; H01M 10/0525; H01M 2/04; H01M 2/18; H01M 10/04

(57) ABSTRACT

A power storage apparatus includes an electrode assembly in which negative electrodes and positive electrodes are stacked alternately with separators located in between, a case main body that accommodates the electrode assembly, and a lid member that closes an opening of the case main body. The bottom-side edge and the side edges of each positive electrode are located inward of the bottom-side edge and the side edges of each negative electrode. A rounded inside corner is formed at an intersection between an inner surface of each side wall and the inner bottom surface of the bottom wall. A gap exists between the bottom surface of the electrode assembly and the inner bottom surface of the case main body. The gap includes a dimension in the depth direction that is 1 to 1.5 times a radius of the inside corner.

### TECHNICAL FIELD

The present invention relates to a power storage apparatus that includes rounded corners at intersections between the inner surfaces of a pair of side walls of a case main body and an inner bottom surface of a bottom wall of the case main body and to a method for manufacturing the power storage apparatus.

### BACKGROUND ART

Vehicles such as electric vehicles (EVs) and plug-in hybrid vehicles (PHVs) include a rechargeable battery such as a lithium-ion battery as a power storage apparatus that stores electric power to be supplied to a drive source, which is an electric motor. For example, a rechargeable battery disclosed in Patent Document 1 includes an electrode assembly and a case. The electrode assembly includes rectangular sheet-like positive electrodes and negative electrodes stacked on one another with separators located in between. The positive electrodes and negative electrodes have active material layers. The case accommodates the electrode assembly. The case includes a case main body, which has an opening for accommodating the electrode assembly, and a lid, which closes the opening of the case main body.

### PRIOR ART DOCUMENT

### Patent Document

Patent Document 1: Japanese Laid-Open Patent Publication No. 9-120836

### SUMMARY OF THE INVENTION

### Problems that the Invention is to Solve

Cases made of metal such as aluminum, which has excellent durability, are often used as the case main body and the lid of the rechargeable battery. In such a case main body, for reasons of manufacturing, rounded corners are inevitably formed at the sections along the sides of the inner bottom surface. The positive electrodes, the negative electrodes, and the separators include square corners at the four corners in a plan view for reasons of manufacturing. Thus, when the electrode assembly is viewed in a stacking direction, the edges at the bottom are square corners. Consequently, in the rechargeable battery, the corners of the positive electrodes and the negative electrodes contact the rounded sections of the inside corners of the case main body as viewed in the stacking direction of the electrode assembly, so that the active material is detached from the opposed portions of positive electrode active material layers and negative electrode active material layers. This results in an undesirable decrease in the battery performance.

Accordingly, it is an objective of the present invention to provide a power storage apparatus that restricts the corners of an electrode assembly from contacting the inside corners of a case to restrict a decrease in the performance and a method for manufacturing the power storage apparatus.

### Means for Solving the Problems

To achieve the foregoing objective, a power storage apparatus is provided that includes an electrode assembly, a case main body, and a lid member. In the electrode assembly, a plurality of negative electrodes each including a negative electrode active material layer and a plurality of positive electrodes each including a positive electrode active material layer are stacked alternately with separators located in between. As viewed in a stacking direction, the positive electrode active material layer is located in a region of the negative electrode active material layer, and an entire surface of the positive electrode active material layer is opposed to the negative electrode active material layer. The case main body accommodates the electrode assembly. The lid member closes an opening of the case main body. The electrode assembly includes a bottom surface and a pair of side surfaces. The bottom surface is formed by bottom-side edges of the negative electrodes and bottom-side edges of the separators and is opposed to an inner bottom surface of the case main body. The side surfaces are formed by side edges of the negative electrodes and side edges of the separators and are connected to the bottom surface and flat surfaces on opposite ends in the stacking direction. A bottom-side edge and the side edges of each positive electrode are located inward of the bottom-side edge and the side edges of each negative electrode as viewed in the stacking direction. The case main body includes a bottom wall that is opposed to the bottom surface of the electrode assembly and forms the inner bottom surface and side walls opposed to the side surfaces. The power storage apparatus includes an inside corner at an intersection between an inner surface of each side wall and the inner bottom surface of the bottom wall. The inside corner is rounded as viewed in the stacking direction of the electrode assembly. A direction in which a straight line that is orthogonal to the inner bottom surface of the case main body extends is a depth direction. A gap exists in the case main body. The gap is formed by separating the bottom surface of the electrode assembly and the inner bottom surface of the case main body from each other in the depth direction. The gap includes a dimension in the depth direction that is 1 to 1.5 times a radius of the inside corner.

To achieve the foregoing objective, a method for manufacturing a power storage apparatus is provided. The power storage apparatus includes an electrode assembly, a case main body, and a lid member. In the electrode assembly, a plurality of negative electrodes each including a negative electrode active material layer and a plurality of positive electrodes each including a positive electrode active material layer are stacked alternately with separators located in between. As viewed in a stacking direction, the positive electrode active material layer is located in a region of the negative electrode active material layer, and an entire surface of the positive electrode active material layer is opposed to the negative electrode active material layer. The case main body accommodates the electrode assembly. The lid member closes an opening of the case main body. The electrode assembly includes a bottom surface and a pair of side surfaces. The bottom surface is formed by bottom-side edges of the negative electrodes and bottom-side edges of the separators and is opposed to an inner bottom surface of the case main body. The side surfaces are formed by side edges of the negative electrodes and side edges of the separators and are connected to the bottom surface and flat surfaces on opposite ends in the stacking direction. A bottom-side edge and the side edges of each positive electrode are located inward of the bottom-side edge and the side edges of each negative electrode as viewed in the stacking direction. The case main body includes a bottom wall that is opposed to the bottom surface of the electrode assembly and forms the inner bottom surface and side walls opposed to the side surfaces. The power storage apparatus includes an inside corner at an intersection between an inner surface of each side wall and the inner bottom surface of the bottom wall. The inside corner is rounded as viewed in the stacking direction of the electrode assembly. The method includes press-fitting the electrode assembly into the case main body from the bottom surface such that the bottom surface of the electrode assembly and the inner bottom surface of the case main body are spaced apart in a depth direction by a dimension 1 to 1.5 times a radius of the inside corner. The depth direction is a direction in which a straight line that is orthogonal to the inner bottom surface of the case main body extends.

With this configuration, as viewed in the stacking direction of the electrode assembly, each negative electrode includes corners at intersections between the bottom-side edge and the side edges, and each separator includes corners at intersections between the bottom-side edge and the side edges. When the gap is provided so that the dimension of the gap is one time the radius of the inside corner, the bottom surface of the electrode assembly is designed to be located at the boundary between the inner surface of each side wall and the associated inside corner. Thus, the corners of negative electrodes and the separators are not located at the rounded sections of the inside corners, so that the active material is prevented from being detached from the negative electrode active material layer.

However, due to the stacking misalignment and the manufacturing tolerances, the corners of the negative electrodes and the separators may possibly be located at the rounded sections of the inside corners. Even in that case, in regard to the separators, the corners contact the rounded sections and only flex. In regard to the negative electrode, parts of the negative electrode active material layer that are not opposed to the positive electrode active material layer are located at the rounded sections. Thus, the active material is not detached from the section of the negative electrode active material layer opposed to the positive electrode active material layer, so that the performance of the power storage apparatus is not decreased.

When the gap is provided so that the dimension of the gap is 1.5 times the radius of the inside corners, the corners of the negative electrodes and the separators are designed to be spaced apart from the rounded sections of the inside corners, so that the active material is not detached from the negative electrode active material layer. Furthermore, even if the stacking misalignment or the manufacturing tolerances occur, the corners of the negative electrodes and the separators do not reach the rounded sections of the inside corners. Thus, since the gap is provided so that the dimension of the gap is 1 to 1.5 times the radius of the inside corners, the active material is prevented from being detached from the section of the negative electrode active material layer opposed to the positive electrode active material layer, so that the performance is not decreased.

In the power storage apparatus, the separators are the bag-shaped separators in each of which the positive electrode is accommodated.

With this configuration, the corners of the positive electrodes are not located at the inside corners.

To achieve the foregoing objective, a power storage apparatus is provided that includes an electrode assembly, a case main body, and a lid member. In the electrode assembly, a plurality of negative electrodes each including a negative electrode active material layer and a plurality of positive electrodes each including a positive electrode active material layer are stacked alternately with separators located in between. As viewed in a stacking direction, the positive electrode active material layer is located in a region of the negative electrode active material layer, and an entire surface of the positive electrode active material layer is opposed to the negative electrode active material layer. The case main body accommodates the electrode assembly. The lid member closes an opening of the case main body. The electrode assembly includes a bottom surface and a pair of side surfaces. The bottom surface is formed by bottom-side edges of the negative electrodes and bottom-side edges of the separators and is opposed to an inner bottom surface of the case main body. The side surfaces are formed by side edges of the negative electrodes and side edges of the separators and are connected to the bottom surface and flat surfaces on opposite ends in the stacking direction. A bottom-side edge and the side edges of each positive electrode are located inward of the bottom-side edge and the side edges of each negative electrode as viewed in the stacking direction. The case main body includes a bottom wall that is opposed to the bottom surface of the electrode assembly and forms the inner bottom surface and side walls opposed to the side surfaces. The power storage apparatus includes an inside corner at an intersection between an inner surface of each side wall and the inner bottom surface of the bottom wall. The inside corner is rounded as viewed in the stacking direction of the electrode assembly. A direction in which a straight line that is orthogonal to the inner bottom surface of the case main body extends is a depth direction. A gap exists in the case main body, the gap being formed by separating the bottom surface of the electrode assembly and the inner bottom surface of the case main body from each other in the depth direction. The separator includes a surplus section that projects from the bottom-side edge and the side edges of each positive electrode in a surface direction of the separator. A dimension of the inside corner in the depth direction is referred to as an inside corner dimension. A dimension of the surplus section in the depth direction is referred to as a surplus section dimension. The following expressions are satisfied

the surplus section dimension<the inside corner dimension, and

the dimension of the gap≥the inside corner dimension−the surplus section dimension.

To achieve the foregoing objective, a method for manufacturing a power storage apparatus is provided. The power storage apparatus includes an electrode assembly, a case main body, a lid member, positive and negative electrode terminals, and positive and negative electrode conductive members. In the electrode assembly, a plurality of negative electrodes each including a negative electrode active material layer and a plurality of positive electrodes each including a positive electrode active material layer are stacked alternately with separators located in between. As viewed in a stacking direction, the positive electrode active material layer is located in a region of the negative electrode active material layer, and an entire surface of the positive electrode active material layer is opposed to the negative electrode active material layer. The electrode assembly includes a positive electrode tab group in which positive electrode tabs each projecting from an edge of the positive electrode are stacked and a negative electrode tab group in which negative electrode tabs each projecting from an edge of the negative electrode are stacked. The case main body accommodates the electrode assembly. The lid member closes an opening of the case main body. The positive and negative electrode terminals are secured to the lid member. The positive and negative electrode conductive members are each joined to the tab group and the electrode terminal of the same polarity. The electrode assembly includes a bottom surface and a pair of side surfaces. The bottom surface is formed by bottom-side edges of the negative electrodes and bottom-side edges of the separators and is opposed to an inner bottom surface of the case main body. The side surfaces are formed by side edges of the negative electrodes and side edges of the separators and are connected to the bottom surface and flat surfaces on opposite ends in the stacking direction. A bottom-side edge and the side edges of each positive electrode are located inward of the bottom-side edge and the side edges of each negative electrode as viewed in the stacking direction. The case main body includes a bottom wall that is opposed to the bottom surface of the electrode assembly and forms the inner bottom surface and side walls opposed to the side surfaces. The power storage apparatus includes an inside corner at an intersection between an inner surface of each side wall and the inner bottom surface of the bottom wall. The inside corner is rounded as viewed in the stacking direction of the electrode assembly. A direction in which a straight line that is orthogonal to the inner bottom surface of the case main body extends is referred to as a depth direction. The power storage apparatus includes a gap in the case main body. The gap is formed by separating the bottom surface of the electrode assembly and the inner bottom surface of the case main body from each other in the depth direction. The separator includes a surplus section that projects from the bottom-side edge and the side edges of each positive electrode in a surface direction of the separator. A dimension of the inside corner in the depth direction is referred to as an inside corner dimension. A dimension of the surplus section in the depth direction is referred to as a surplus section dimension. The method includes: manufacturing a lid terminal assembly in which the lid member, the positive and negative electrode terminals, and the positive and negative electrode conductive members are integrated; joining each conductive member and the associated tab group of the same polarity to integrate the lid terminal assembly and the electrode assembly; press-fitting the electrode assembly into the case main body such that even if force is applied in the depth direction, a dimension from an outer surface of the lid member to the bottom surface of the electrode assembly in the depth direction stays at a minimum value; and press-fitting the electrode assembly into the case main body until the following expressions are satisfied:

the surplus section dimension<the inside corner dimension, and

the dimension of the gap≥the inside corner dimension−the surplus section dimension.

With this configuration, as viewed in the stacking direction of the electrode assembly, each negative electrode includes the corners at the intersections between the bottom-side edge and the side edges, and each separator includes the corners at the intersections between the bottom-side edge and the side edges. In regard to the negative electrode, even if parts of the negative electrode active material layer that are not opposed to the positive electrode active material layer are located at the rounded sections, the active material is not detached from the section of the negative electrode active material layer that is opposed to the positive electrode active material layer, so that the performance of the power storage apparatus is not decreased. Furthermore, the gap is provided between the bottom surface of the electrode assembly and the inner bottom surface of the case main body. Thus, the positive electrodes are spaced apart from the inner bottom surface of the case main body, so that the positive electrodes are restricted from contacting the inner bottom surface of the case main body. This restricts the active material from being detached from the positive electrode active material layer, so that the performance of the power storage apparatus is not decreased.

Note that due to the stacking misalignment and the manufacturing tolerances, the corners at the surplus section of the separator may possibly be located at the rounded sections of the inside corners. However, even if the surplus section contacts the inside corners along the entire length in the depth direction, the gap is provided in the case main body by satisfying the following expressions: surplus section dimension<inside corner dimension, and dimension of gap≥inside corner dimension−surplus section dimension. As a result, the separators are separated from the inner bottom surface of the case main body, so that the positive electrodes are restricted from contacting the inner bottom surface of the case main body. Consequently, the active material is restricted from being detached from the positive electrode active material layer, so that the performance of the power storage apparatus is not decreased.

In the power storage apparatus, the separators may be bag-shaped separators each accommodating one of the positive electrodes. A pair of separator members that are opposed to each other with the positive electrode located in between may include sections projecting from the edge of the positive electrode, and the surplus section that projects from the bottom-side edge may be formed by welding weldable parts of the projecting sections along the entire length in the depth direction.

With this configuration, the area to be welded is increased to increase the rigidity of the surplus section. As a result, even if the surplus section interferes with the rounded sections of the inside corners, the positive electrodes are protected by the surplus section.

In the power storage apparatus, the electrode assembly may include a positive electrode tab group in which positive electrode tabs each projecting from an edge of the positive electrode are stacked, and a negative electrode tab group in which negative electrode tabs each projecting from an edge of the negative electrode are stacked. The power storage apparatus may include a lid terminal assembly in which positive and negative electrode terminals secured to the lid member and positive and negative electrode conductive members each joined to the tab group and the electrode terminal of the same polarity are integrated. The lid terminal assembly and the electrode assembly may be integrated by joining each conductive member and the associated tab group of the same polarity. The lid member and the case main body may be joined with a dimension from an outer surface of the lid member to the bottom surface of the electrode assembly in the depth direction being a minimum value.

With this configuration, in the case, the electrode assembly and the lid terminal assembly are integrated to be a single rigid body. Thus, the state in which the gap is formed in the case is maintained.

In the power storage apparatus, the positive electrode tab group and the negative electrode tab group may each be bent so as to approach each other in the depth direction.

With this configuration, when the electrode assembly is press-fitted into the case main body, the tab group of each polarity cannot be bent any further, and the dimension from the outer surface of the lid member to the bottom surface of the electrode assembly in the depth direction is the minimum value. This prevents the tab groups from being displaced and provides the gap.

In the power storage apparatus, the surplus section dimension is preferably 0.5 to 2 mm. The inside corner dimension is preferably 1 to 2 mm. The dimension of the gap is preferably greater than 0 and less than or equal to 5 mm.

The power storage apparatus is a rechargeable battery.

### Effects of the Invention

The present invention restricts the corners of an electrode assembly from contacting the inside corners of a case, so that a decrease in the performance is restricted.

### BRIEF DESCRIPTION OF THE DRAWINGS

FIG. 1 is an exploded perspective view of a rechargeable battery according to an embodiment;

FIG. 2 is an exploded perspective view of the components of the electrode assembly;

FIG. 3 is a cross-sectional view showing the inside of the rechargeable battery according to a first embodiment;

FIG. 4A is an enlarged view of a first inside corner according to the first embodiment when the dimension of a gap is one time the radius r;

FIG. 4B is an enlarged view showing a state in which the corner reaches the first inside corner due to, for example, the tolerance according to the first embodiment;

FIG. 5 is an enlarged view of a second inside corner;

FIG. 6 is a view showing a state in which the electrode assembly is press-fitted into the case main body;

FIG. 7A is a view showing a state in which the electrode assembly covered by an insulation member is press-fitted into the case main body; and

FIG. 7B is an enlarged view showing a state in which the corner reached the first

### MODES FOR CARRYING OUT THE INVENTION

### First Embodiment

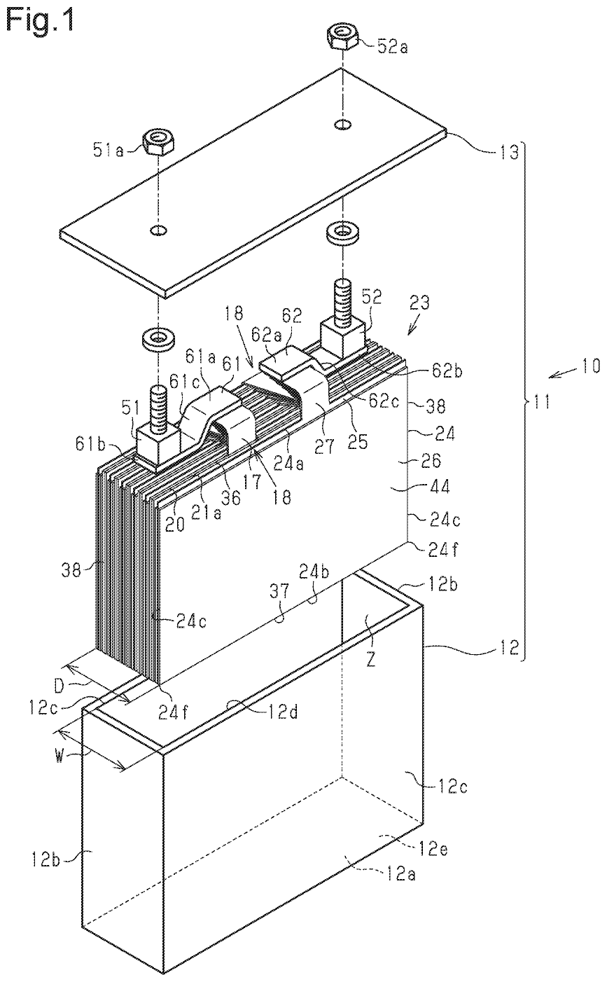

A power storage apparatus and method for manufacturing the same according to a first embodiment will now be described with reference to FIGS. 1 to 6. The apparatus and the method are applied to a rechargeable battery and its manufacturing method.

As shown in FIG. 1, the power storage apparatus, which is a rechargeable battery 10 in this embodiment, includes a rectangular parallelepiped case 11, which accommodates an electrode assembly 23. The case 11 includes a rectangular parallelepiped case main body 12 having a closed end and a rectangular plate-like lid member 13. The lid member 13 and the case main body 12 are welded by laser welding. The case main body 12 includes a rectangular bottom wall 12a, short side walls 12b, and long side walls 12c. The short side walls 12b are side walls extending upright from a pair of opposed short side edges of the bottom wall 12a. The long side walls 12c are long walls extending upright from a pair of opposed long side edges of the bottom wall 12a. An inner bottom surface 12e of the case 11 is formed by the bottom wall 12a of the case main body 12. Hereinafter, the direction in which the straight line that is orthogonal to the inner bottom surface 12e extends is referred to as the depth direction of the case 11. The case main body 12 includes an opening 12d for receiving the electrode assembly 23. The case main body 12 and the lid member 13 are made of metal (for example, stainless steel or aluminum), and the lid member 13 closes the opening 12d. The inner surface of the case main body 12 is entirely covered by an insulation member Z.

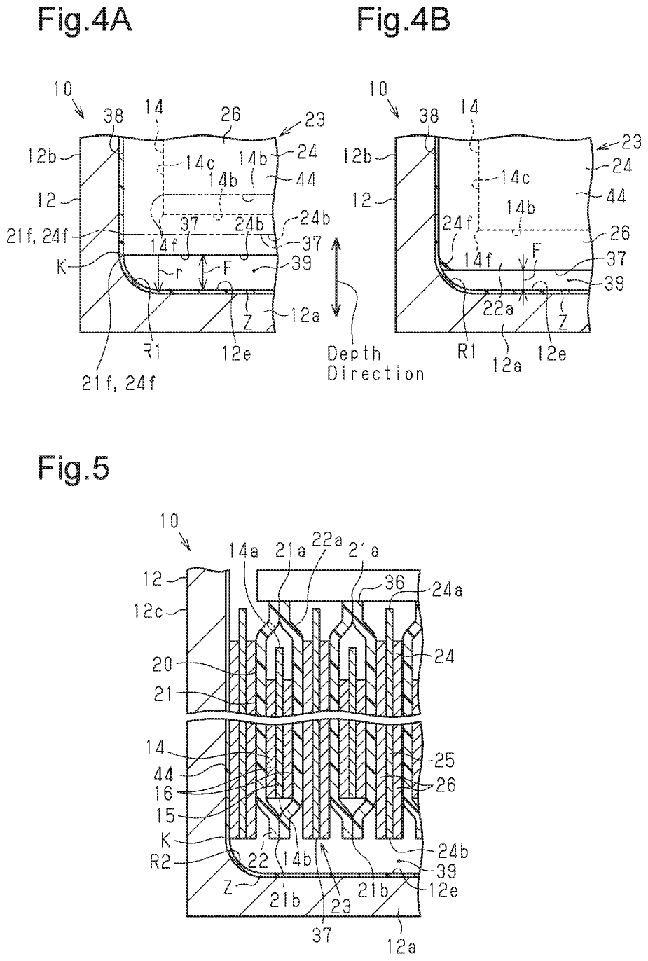

As shown in FIG. 4 or 5, the case main body 12 includes rounded first inside corners R1, which are formed at intersections between the inner surfaces of the short side walls 12b and the inner bottom surface 12e of the bottom wall 12a. More specifically, the first inside corners R1 are rounded sections each located between the flat section of one of the short side walls 12b and the flat section of the bottom wall 12a. The boundary between the flat inner surface of each short side wall 12b and the inner surface of the associated first inside corner R1 is referred to as a boundary K. The case main body 12 also includes rounded second inside corners R2 at intersections between the inner surfaces of the long side walls 12c and the inner bottom surface of the bottom wall 12a. More specifically, the second inside corners R2 are rounded sections each located between the flat section of one of the long side walls 12c and the flat section of the bottom wall 12a. The boundary between the flat inner surface of each long side wall 12c and the inner surface of the associated second inside corner R2 is referred to as a boundary K.

As shown in FIG. 1, the rechargeable battery 10 is a square battery having a square appearance and is a lithium-ion battery.

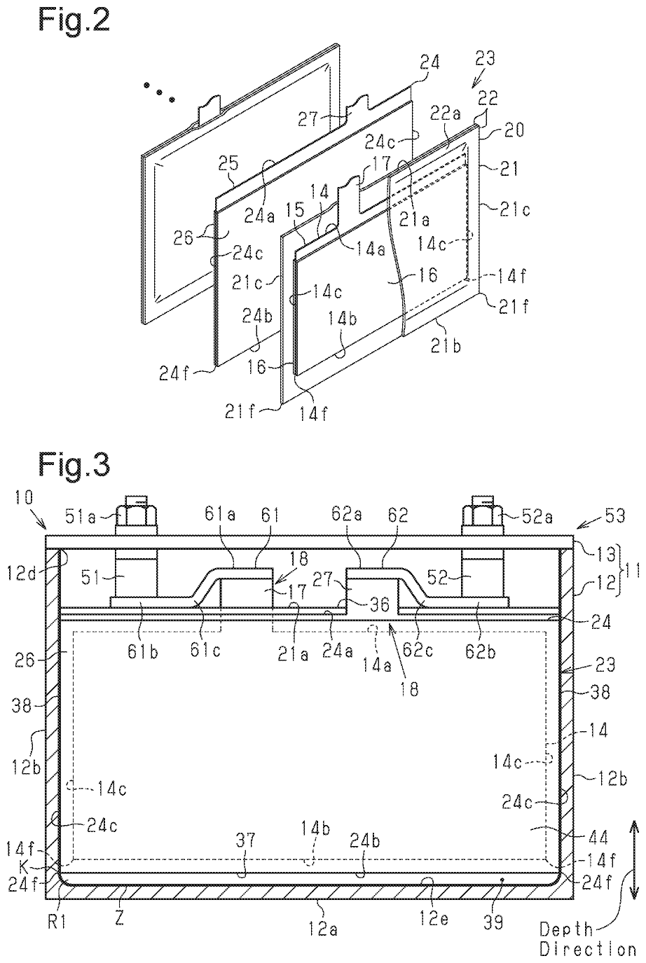

As shown in FIG. 2, the electrode assembly 23 includes electrode accommodating separators 20 and negative electrodes 24. In each electrode accommodating separator 20, a positive electrode 14 is accommodated in a separator, which is a bag-shaped separator 21 in this embodiment. The electrode assembly 23 has a stacking structure in which the electrode accommodating separators 20 and the negative electrodes 24 are stacked alternately. The direction in which the electrode accommodating separators 20 and the negative electrodes 24 are stacked is referred to as a stacking direction. The positive electrodes 14 and the negative electrodes 24 are stacked alternately with the bag-shaped separators 21 of the electrode accommodating separators 20 located in between. In the present embodiment, the positive electrodes 14, the bag-shaped separators 21, and the negative electrodes 24 are rectangular as viewed in the stacking direction.

The positive electrodes 14 each include a current collector, which is a rectangular sheet-like positive metal foil (for example, an aluminum foil) 15 in this embodiment, and positive electrode active material layers 16, which are formed on both sides of the positive metal foil 15. The positive electrodes 14 each include a tab-side edge 14a, which is one of the edges along the pair of long sides as viewed in the stacking direction. The positive electrodes 14 each include a positive electrode tab 17. The positive electrode tab 17 projects from the tab-side edge 14a, which is one of the edges of the positive electrodes 14. The positive electrode tab 17 is a section where the positive electrode active material layer 16 is not applied to the positive metal foil 15 and is constituted by the positive metal foil 15 itself. The positive electrodes 14 each include, as viewed in the stacking direction, a bottom-side edge 14b on the edge opposite to the tab-side edge 14a and side edges 14c on a pair of edges connecting the tab-side edge 14a and the bottom-side edge 14b to each other. The positive electrodes 14 each include, as viewed in the stacking direction, corners 14f formed at intersections between the bottom-side edge 14b and the side edges 14c. The corners 14f are right angles as viewed in the stacking direction.

The negative electrodes 24 each include a current collector, which is a rectangular sheet-like negative electrode metal film (for example, a copper film) 25 in this embodiment, and negative electrode active material layers 26, which are formed on both sides of the negative electrode metal film 25. The negative electrode active material layers 26 include negative active material. The negative electrodes 24 each include a tab-side edge 24a, which is one of the edges along the pair of long sides. The negative electrodes 24 each include a negative electrode tab 27. The negative electrode tab 27 projects from the tab-side edge 24a, which is one of the edges of the negative electrodes 24. The negative electrode tab 27 is a section where the negative electrode active material layer 26 is not applied to the negative electrode metal film 25 and is constituted by the negative electrode metal film 25 itself. The negative electrode 24 each include a bottom-side edge 24b on the edge opposite to the tab-side edge 24a and side edges 24c on the edges along the pair of short sides connecting the tab-side edge 24a and the bottom-side edge 24b. The negative electrodes 24 each include, as viewed in the stacking direction, corners 24f formed at intersections between the bottom-side edge 24b and the side edges 24c. The corners 24f are right angles as viewed in the stacking direction.

When the negative electrodes 24 and the positive electrodes 14 are viewed in the stacking direction, the length of the tab-side edges 24a of the negative electrodes 24 is longer than the length of the tab-side edges 14a of the positive electrodes 14, and the length of the bottom-side edges 24b of the negative electrodes 24 is longer than the length of the bottom-side edges 14b of the positive electrodes 14. Furthermore, the length of the side edges 24c of the negative electrodes 24 is longer than the length of the side edges 14c of the positive electrodes 14. Thus, as viewed in the stacking direction, the negative electrodes 24 are slightly larger than the positive electrodes 14. In the electrode assembly 23, the four edges of each positive electrode 14 are located inward of the four edges of each negative electrode 24. More specifically, when the electrode assembly 23 is viewed in the stacking direction, the bottom-side edge 14b and the side edges 14c of each positive electrode 14 are located inward of the bottom-side edge 24b and the side edges 24c of each negative electrode 24. Thus, when the electrode assembly 23 is viewed in the stacking direction, the positive electrode active material layers 16 are located in the region of the negative electrode active material layers 26, and the entire surface of each positive electrode active material layer 16 is opposed to the associated negative electrode active material layer 26.

Each bag-shaped separator 21 includes a pair of rectangular sheet-like separator members 22, which are opposed to each other. The separator members 22 are made of insulating plastic (for example, polyethylene). Each bag-shaped separator 21 includes a tab-side edge 21a, which is parallel to the tab-side edge 14a of the positive electrode 14. The bag-shaped separator 21 includes a bottom-side edge 21b, which is parallel to the bottom-side edge 14b of the positive electrode 14 on the edge opposite to the tab-side edge 21a. The bag-shaped separator 21 also includes side edges 21c on a pair of edges connecting the tab-side edge 21a and the bottom-side edge 21b. The side edges 21c are parallel to the side edges 14c of the positive electrode 14. The bag-shaped separator 21 includes corners 21f, which are formed at the intersections between the bottom-side edge 21b and the side edges 21c as viewed in the stacking direction. The corners 21f are right angles as viewed in the stacking direction.

The bag-shaped separator 21 includes a surplus section 22a, which projects from the tab-side edge 14a, the bottom-side edge 14b, and the pair of side edges 14c of the positive electrode 14 in the surface direction of the positive electrode 14. The surplus section 22a is shaped like a rectangular loop surrounding the positive electrode 14. The surplus section 22a is formed by welding the sections of the separator members 22, which are opposed to each other with the positive electrode 14 located in between, projecting from the positive electrode 14. The part of the surplus section 22a projecting from the bottom-side edge 14b is formed by welding the sections of the pair of separator members 22 that project from the bottom-side edge 14b and can be welded to each other along the entire length in the depth direction.

As shown in FIG. 1, the electrode accommodating separators 20 and the negative electrodes 24 are stacked so that the positive electrode tabs 17 are aligned in the stacking direction, and the negative electrode tabs 27 are aligned in the stacking direction at a position that does not overlap the positive electrode tabs 17. The dimension of the electrode assembly 23 in the stacking direction is referred to as a thickness D. In the case main body 12, when the length of the straight line that connects the inner surfaces of the opposed long side walls 12c with each other in the shortest distance is referred to as an opening width W of the case main body 12, the thickness D of the electrode assembly 23 before being accommodated in the case main body 12 is slightly thicker than the opening width W. Thus, the electrode assembly 23 is press-fitted into the case main body 12.

As shown in FIG. 5, in the electrode assembly 23, the bottom-side edges 21b of the bag-shaped separators 21 and the bottom-side edges 24b of the negative electrodes 24 are flush with each other. The electrode assembly 23 includes a bottom surface 37 constituted by the bottom-side edges 21b and 24b. Additionally, in the electrode assembly 23, the tab-side edges 21a of the bag-shaped separators 21 are located closer to the lid member 13 than the tab-side edges 24a of the negative electrodes 24. The electrode assembly 23 includes a tab-side end face 36 constituted by the tab-side edges 21a.

As shown in FIG. 1, on the tab-side end face 36, the positive electrode tabs 17 and the negative electrode tabs 27 are collected (bundled) in a range from one end of the electrode assembly 23 to the other end in the stacking direction and are bent to form tab groups 18. The tab group 18 of each polarity is folded so that one part approaches another part in the depth direction. Since the tab group 18 of each polarity is formed by stacking the positive electrode tabs 17 or the negative electrode tabs 27, which are flexible, the tab groups 18 are flexible. However, in a state in which the tab group 18 of each polarity is folded in the case 11, the tab group 18 is bent until it is compressed to the maximum degree in the depth direction. Thus, the tab group 18 of each polarity cannot be deformed any further and has no flexibility.

As shown in FIG. 1 or 3, the electrode assembly 23 includes a pair of side surfaces 38, which are constituted by the side edges 21c of the bag-shaped separators 21 and the side edges 24c of the negative electrodes 24. The pair of side surfaces 38 are two surfaces that are orthogonal to (intersect) the flat surfaces 44 on the opposite ends of the electrode assembly 23 in the stacking direction among the surfaces of the electrode assembly 23 connected to the bottom surface 37.

The overlapping sections of the positive electrode tabs 17 are welded, so that the positive electrode tabs 17 are electrically connected. The tab group 18 formed by the positive electrode tabs 17 is connected to a positive electrode conductive member 61. When the electrode assembly 23 is viewed in the stacking direction, the positive electrode conductive member 61 is shaped like a crank. The positive electrode conductive member 61 includes a tab-side joint section 61a, which is connected to the tab group 18 formed by the positive electrode tabs 17, a terminal joint section 61b, which is closer to the tab-side end face 36 of the electrode assembly 23 than the tab-side joint section 61a, and a coupling portion 61c, which couples the tab-side joint section 61a to the terminal joint section 61b. The terminal joint section 61b is connected to a positive electrode terminal 51 for extracting electricity from the electrode assembly 23.

Similarly, the overlapping sections of the negative electrode tabs 27 are welded, so that the negative electrode tabs 27 are electrically connected. The tab group 18 formed by the negative electrode tabs 27 is connected to a negative electrode conductive member 62. When the electrode assembly 23 is viewed in the stacking direction, the negative electrode conductive member 62 is shaped like a crank. The negative electrode conductive member 62 includes a tab-side joint section 62a, which is connected to the tab group 18 formed by the negative electrode tabs 27, a terminal joint section 62b, which is closer to the tab-side end face 36 of the electrode assembly 23 than the tab-side joint section 62a, and a coupling portion 62c, which couples the tab-side joint section 62a to the terminal joint section 62b. The terminal joint section 62b is connected to a negative electrode terminal 52 for extracting electricity from the electrode assembly 23.

A method for manufacturing the rechargeable battery 10 will be described.

First, the electrode assembly 23 as described above is manufactured. Subsequently, the positive electrode terminal 51 is welded to the terminal joint section 61b of the positive electrode conductive member 61. The negative electrode terminal 52 is also welded to the terminal joint section 62b of the negative electrode conductive member 62. Subsequently, an external screw of the positive electrode terminal 51 and an external screw of the negative electrode terminal 52 are inserted through the lid member 13. A nut 51a is screwed to the positive external screw, and a nut 52a is screwed to the negative external screw. Thus, the positive electrode terminal 51 and the negative electrode terminal 52 are fastened to the lid member 13. As a result, the lid member 13, the positive electrode terminal 51, the negative electrode terminal 52, the positive electrode conductive member 61, and the negative electrode conductive member 62 are integrated to constitute a lid terminal assembly 53.

Subsequently, the tab group 18 of the positive polarity is welded to the tab-side joint section 61a of the positive electrode conductive member 61, and the tab group 18 of the negative polarity is welded to the tab-side joint section 62a of the negative electrode conductive member 62. Thus, the lid terminal assembly 53 and the electrode assembly 23 are integrated through the tab group 18 of the positive polarity and the tab group 18 of the negative polarity.

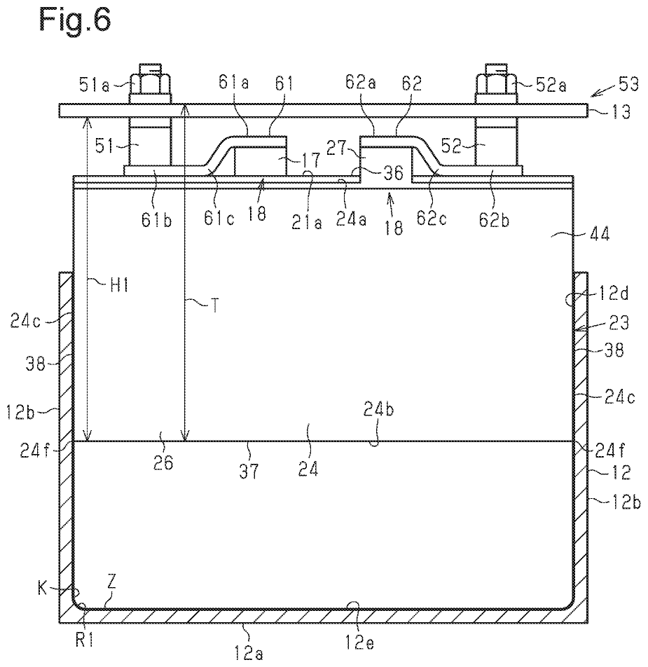

Next, as shown in FIG. 6, the lid member 13 of the lid terminal assembly 53 is pushed into the electrode assembly 23 by a predetermined force, so that the electrode assembly 23 is press-fitted into the case main body 12. At this time, when the lid member 13 is pushed toward the electrode assembly 23, since the tab groups 18 that have not been bent have flexibility, the tab groups 18 are compressed in the depth direction and are bent. When both tab groups 18 are bent until they are compressed to the maximum degree in the depth direction, the tab groups 18 lose flexibility, so that the lid terminal assembly 53 and the electrode assembly 23 become a single rigid body. At this time, the dimension T from the outer surface of the lid member 13 to the bottom surface 37 of the electrode assembly 23 in the depth direction becomes the minimum value. The predetermined force for pushing the lid terminal assembly 53 is the force necessary for press-fitting the electrode assembly 23 into the case main body 12. The state in which the dimension T stays at the minimum value even if the predetermined force is applied is understood as the state in which the lid terminal assembly 53 and the electrode assembly 23 became a single rigid body.

When the press-fitting of the electrode assembly 23 into the case main body 12 is completed, the lid member 13 is joined to the case main body 12 to close the opening 12d of the case main body 12. This completes the assembly of the rechargeable battery 10. In FIG. 6, the inner surface of the case main body 12 is covered by the insulation member Z.

As shown in FIG. 3 or 4A, in the rechargeable battery 10, the bottom surface 37 of the electrode assembly 23 and the inner bottom surface 12e of the case main body 12, on which the insulation member Z is formed, are spaced apart in the depth direction, so that a gap 39 exists between the bottom surface 37 and the inner bottom surface 12e of the case main body 12 of the case 11. When the rechargeable battery 10 is viewed in the stacking direction, the bottom surface 37 of the electrode assembly 23 is located at the boundaries K of the first inside corners R1 in the depth direction, and the corners 21f of the bag-shaped separators 21 and the corners 24f of the negative electrodes 24 are not located at the rounded sections of the first inside corners R1.

A dimension F of the gap 39 in the depth direction is 1 to 1.5 times the radius r of the first inside corners R1. When the dimension F of the gap 39 is less than one time the radius r of the first inside corners R1, the corners 21f of the bag-shaped separators 21 and the corners 24f of the negative electrodes 24 contact the rounded sections of the first inside corners R1, so that the first inside corners R1 may possibly deform the corners 21f and 24f, which is not preferred.

When the dimension F of the gap 39 exceeds 1.5 times the radius r of the first inside corners R1, the bottom surface 37 of the electrode assembly 23 is closer to the lid member 13 than the boundaries K as shown by the long dashed double-short dashed lines in FIG. 4A. Thus, the volume of the electrode assembly 23 is undesirably reduced, so that the battery capacity is decreased, which is not preferred. Thus, the dimension F of the gap 39 is set to 1 to 1.5 times the radius r of the first inside corners R1.

During the stacking of the bag-shaped separators 21 and the negative electrodes 24, the stacking misalignment might occur in which the bottom-side edges 21b of the bag-shaped separators 21 and the bottom-side edges 24b of the negative electrodes 24 are misaligned. Furthermore, the dimension of the side edges 21c and 24c of the bag-shaped separators 21 and the negative electrodes 24 has a tolerance. In the electrode assembly 23, the tolerance is set in consideration of the stacking misalignment and the manufacturing tolerances of the bag-shaped separators 21 and the negative electrodes 24.

As shown in FIG. 4B, if the dimension of the electrode assembly 23 in the depth direction becomes the maximum of the tolerance due to the stacking misalignment and the manufacturing tolerances of the bag-shaped separators 21, with the dimension F of the gap 39 set to one time the radius r of the first inside corners R1, the surplus sections 22a of the bag-shaped separators 21 contact the rounded sections of the first inside corners R1. However, it is only the surplus sections 22a that contact the rounded sections of the first inside corners R1, and the corners 14f of the positive electrodes 14 are located closer to the lid member 13 than the first inside corners R1 and do not contact the rounded sections of the first inside corners R1.

Additionally, if the dimension of the electrode assembly 23 in the depth direction becomes the maximum of the tolerance due to the stacking misalignment or the manufacturing tolerances of the negative electrodes 24, with the dimension F of the gap 39 set to one time the radius r of the first inside corners R1, the corners 24f of the negative electrodes 24 contact the rounded sections of the first inside corners R1. However, even if the negative electrode active material layers 26 are damaged, the corners 14f of the positive electrode active material layers 16 do not contact the rounded sections of the first inside corners R1. Consequently, the opposed sections of the positive electrode active material layers 16 and the negative electrode active material layers 26 are not affected.

When the dimension F of the gap 39 is 1.5 times the radius r of the first inside corners R1, even if the dimension of the electrode assembly 23 in the depth direction becomes the maximum of the tolerance, the corners 21f and 24f are located at the boundaries K of the first inside corners R1 on the short side walls 12b and do not contact the rounded sections of the first inside corners R1.

To allow the gap 39 to have the dimension F, in the present embodiment, the dimension from the inner surface of the lid member 13 to the bottom surface 37 of the electrode assembly 23 in the depth direction, which is a height H1 in this embodiment, or a dimension T from the outer surface of the lid member 13 to the bottom surface 37 of the electrode assembly 23 is adjusted as shown in FIG. 6 with the lid terminal assembly 53 and the electrode assembly 23 being integrated. The height H1 is set with the positive electrode tabs 17 and the negative electrode tabs 27 being bent.

Next, the operations of the rechargeable battery 10 will be described.

As shown in FIG. 6, when the electrode assembly 23, which is integrated with the lid terminal assembly 53, is inserted in the case main body 12 through the opening 12d of the case main body 12, the electrode assembly 23 is press-fitted into the case main body 12 since the thickness D of the electrode assembly 23 is slightly thicker than the opening width W. For this reason, the electrode assembly 23 will not fall into the case main body 12. However, since the electrode assembly 23 needs to be press-fit into the case main body 12, the lid member 13 of the lid terminal assembly 53 is pushed toward the electrode assembly 23 with the predetermined force.

The pushing force applied to the lid terminal assembly 53 is transmitted to the electrode assembly 23 through the positive electrode tabs 17 and the negative electrode tabs 27. The terminal joint sections 61b and 62b press the tab-side edges 21a of the bag-shaped separators 21 exposed on the tab-side end face 36 of the electrode assembly 23. The electrode assembly 23 is press-fitted while an image inspection of the bottom surface 37 of the electrode assembly 23 is performed to check the dimension F of the gap 39. That is, the electrode assembly 23 is press-fitted into the case main body 12 so that the bottom surface 37 of the electrode assembly 23 is spaced apart from the inner bottom surface 12e in the depth direction by the dimension that is 1 to 1.5 times the radius r of the first inside corners R1. Thus, the electrode assembly 23 is accommodated in the case main body 12 in a state before the bottom surface 37 of the electrode assembly 23 reaches the first inside corners R1, or when the bottom surface 37 is at the boundaries K of the first inside corners R1, so that the gap 39 is provided. After the electrode assembly 23 is accommodated in the case main body 12, the lid member 13 and the case main body 12 are joined to close the opening 12d of the case main body 12. This completes the assembly of the rechargeable battery 10.

The first embodiment has the following advantages.

(1-1) The dimension F of the gap 39 in the depth direction is set to 1 to 1.5 times the radius r of the first inside corners R1. Thus, the bottom surface 37 of the electrode assembly 23 is designed not to reach the rounded sections of the first inside corners R1. This prevents the corners 21f of the bag-shaped separators 21 from being bent and the corners 24f of the negative electrodes 24 from being damaged by the rounded sections of the first inside corners R1 and thus prevents the active material from being detached.

During the manufacture of the electrode assembly 23, due to the occurrence of the stacking misalignment of the bag-shaped separators 21 and the negative electrodes 24 or the manufacturing tolerances of the negative electrodes 24, the bottom-side edges 21b of the bag-shaped separators 21 or the bottom-side edges 24b of the negative electrodes 24 may be located close to the bottom wall 12a of the case main body 12. In this case also, if the dimension F of the gap 39 is set to 1.5 times the radius r of the first inside corners R1, the corners 21f of the bag-shaped separators 21 or the corners 24f of the negative electrodes 24 will not be located at the rounded sections of the first inside corners R1. If the dimension F of the gap 39 is set to one time the radius r of the first inside corners R1, due to the occurrence of the stacking misalignment of the bag-shaped separators 21 and the negative electrodes 24 or the manufacturing tolerances of the negative electrodes 24, the corners 21f of the bag-shaped separators 21 or the corners 24f of the negative electrodes 24 may possibly be located at the rounded sections of the first inside corners R1. In this case also, even if the negative electrode active material layers 26 get damaged, the sections of the negative electrode active material layers 26 opposed to the positive electrode active material layers 16 are not damaged. Thus, the battery performance is not affected.

(1-2) The positive electrodes 14 are each accommodated in the associated bag-shaped separator 21. Each bag-shaped separator 21 prevents the corners 14f of the associated positive electrode 14 from contacting the rounded sections of the first inside corners R1, so that the opposed sections of the positive electrode active material layer 16 and the negative electrode active material layer 26 are not affected.

(1-3) The upper limit value of the dimension F of the gap 39 in the depth direction is set to 1.5 times the radius r of the first inside corners R1, so that the bottom surface 37 of the electrode assembly 23 is not excessively spaced apart from the bottom wall 12a. Thus, in the inspection of the rechargeable battery 10, when the image inspection is performed on the bottom surface 37 of the electrode assembly 23, the bottom surface 37 is shown in the image. Thus, the image inspection is not hindered.

### Second Embodiment

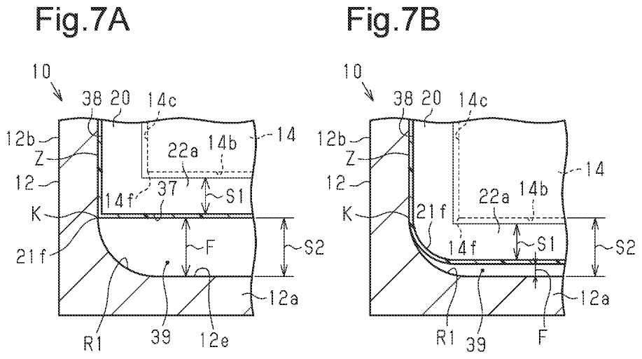

A power storage apparatus and method for manufacturing the same according to a second embodiment will now be described with reference to FIG. 7. The detailed description of the configuration of the second embodiment that is the same as the first embodiment will be omitted.

As shown in FIG. 7A, the bottom surface 37, the side surfaces 38, and the flat surfaces 44 of the electrode assembly 23 are covered by the insulation member Z.

The dimension of the part of the surplus section 22a of the electrode accommodating separator 20 projecting from the bottom-side edge 14b of the positive electrode 14 in the depth direction is referred to as a surplus section dimension S1. The dimension of the first inside corners R1 in the depth direction is referred to as an inside corner dimension S2. The inside corner dimension S2 of the first inside corners R1 is the dimension from each boundary K to the inner bottom surface 12e in the depth direction. The dimension of the gap 39 in the depth direction is denoted as the dimension F.

In the second embodiment, the dimension F of the gap 39 is greater than 0 mm and less than or equal to 5 mm. When the dimension F of the gap 39 becomes greater than 5 mm, the bottom surface 37 of the electrode assembly 23 is closer to the lid member 13 than the boundary K. Thus, the volume of the electrode assembly 23 is undesirably reduced, so that the battery capacity is decreased, which is not preferred. For this reason, the dimension F of the gap 39 is preferably less than or equal to 3 mm and more preferably less than or equal to 1 mm. The surplus section dimension S1 of the bag-shaped separator 21 is preferably 0.5 to 2 mm. The inside corner dimension S2 of the first inside corners R1 is preferably 1 to 2 mm. In a state in which the bottom surface 37 of the electrode assembly 23, on which the insulation member Z is applied, is located at the boundaries K, the dimension F of the gap 39 is 1 to 2 mm.

In the second embodiment, the following expressions 1 and 2 are satisfied.

The surplus section dimension S1<the inside corner dimension S2 Expression 1

The dimension F of gap≥the inside corner dimension S2−surplus section dimension S1 Expression 2

To manufacture the rechargeable battery 10 of the second embodiment, first, the electrode assembly 23 and the lid terminal assembly 53 are manufactured, and the electrode assembly 23 and the lid terminal assembly 53 are integrated as in the first embodiment. The electrode assembly 23 is covered by the insulation member Z. The lid member 13 is pushed toward the electrode assembly 23 by the predetermined force to press-fit the electrode assembly 23 into the case main body 12.

The electrode assembly 23 is press-fitted while the image inspection of the bottom surface 37 of the electrode assembly 23 is performed to check the dimension F of the gap 39. The electrode assembly 23 is press-fitted into the case main body 12 so that the bottom surface 37 of the electrode assembly 23 is spaced apart from the inner bottom surface 12e in the depth direction in a state in which the expressions 1 and 2 are satisfied. When the press-fitting of the electrode assembly 23 into the case main body 12 is completed, the lid member 13 is joined to the case main body 12 to close the opening 12d of the case main body 12. This completes the assembly of the rechargeable battery 10.

The second embodiment has the following advantages.

(2-1) The gap 39 is provided between the bottom surface 37 of the electrode assembly 23 and the inner bottom surface 12e of the case main body 12. Thus, the bag-shaped separators 21 are separated from the bottom wall 12a of the case main body 12, so that the positive electrodes 14 accommodated in the bag-shaped separators 21 are restricted from contacting the inner bottom surface 12e of the bottom wall 12a. As a result, the active material is restricted from being detached from the positive electrode active material layers 16 of the positive electrodes 14, so that the performance of the rechargeable battery 10 is prevented from being decreased. In regard to the negative electrodes 24, even if the sections of the negative electrode active material layers 26 that are not opposed to the positive electrode active material layers 16 are located at the first inside corners R1, the active material is not detached from the sections of the negative electrode active material layers 26 opposed to the positive electrode active material layers 16, so that the performance of the rechargeable battery 10 is prevented from being decreased.

(2-2) As shown in FIG. 7B, if the dimension of the electrode assembly 23 in the depth direction becomes the maximum of the tolerance due to the stacking misalignment or the manufacturing tolerances of the bag-shaped separators 21, the corners 21f of the bag-shaped separators 21 contact the rounded sections of the first inside corners R1. Even if the surplus sections 22a of the bag-shaped separators 21 contact the first inside corners R1 along the entire length in the depth direction, since the inside corner dimension S2 of the first inside corners R1 is longer than the surplus section dimension S1 of the surplus section 22a, the gap 39 is provided between the surplus sections 22a (the bottom surface 37 of the electrode assembly 23) and the inner bottom surface 12e of the case main body 12 in the depth direction. As a result, the bag-shaped separators 21 are separated from the bottom wall 12a of the case main body 12, so that the positive electrodes 14 accommodated in the bag-shaped separators 21 are restricted from contacting the inner bottom surface 12e of the bottom wall 12a. Consequently, the active material is restricted from being detached from the positive electrode active material layers 16 of the positive electrodes 14, so that the performance of the rechargeable battery 10 is prevented from being decreased.

(2-3) The surplus section 22a of each bag-shaped separator 21 is formed by welding the sections of the pair of separator members 22 that project from the bottom-side edge 14b and can be welded to each other along the entire length in the depth direction. Thus, the welded area is increased to increase the rigidity of the surplus section 22a. As a result, even if the surplus sections 22a interfere with the first inside corners R1, the positive electrodes 14 are protected by the surplus sections 22a.

(2-4) The tab group 18 of each polarity is folded. Thus, when the electrode assembly 23 is press-fitted into the case main body 12, the displacement of the tab groups 18 may possibly cause the bottom surface 37 of the electrode assembly 23 to interfere with the rounded sections of the first inside corners R or result in failing to form the gap 39. However, when the electrode assembly 23 is press-fitted into the case main body 12, the tab group 18 of each polarity is in a state in which the tab group 18 cannot be bent any further, and the dimension T from the outer surface of the lid member 13 to the bottom surface 37 of the electrode assembly 23 in the depth direction is the minimum value, or the height H1 from the inner surface of the lid member 13 to the bottom surface 37 of the electrode assembly 23 is the minimum value. Thus, the gap 39 is provided between the electrode assembly 23 and the inner bottom surface 12e of the case main body 12.

(2-5) The tab group 18 of each polarity is compressed in the depth direction and is limited from being bent any further. With these tab groups 18, the dimension T from the outer surface of the lid member 13 to the bottom surface 37 of the electrode assembly 23 in the depth direction or the height H1 from the inner surface of the lid member 13 to the bottom surface 37 of the electrode assembly 23 is the minimum value. In this state, when the lid terminal assembly 53 and the electrode assembly 23 are pushed into the case main body 12 so that the expressions 1 and 2 are satisfied, the gap 39 is formed between the bottom surface 37 of the electrode assembly 23 and the inner bottom surface 12e of the case main body 12 even if the corners 21f of the bag-shaped separators 21 interfere with the first inside corners R1.

The above-described embodiments may be modified as follows.

In the first embodiment also, the dimension of the surplus section 22a in the depth direction may be referred to as the surplus section dimension S 1, and the dimension of the first inside corners R1 in the depth direction may be referred to as the inside corner dimension S2. The first embodiment may be configured to satisfy the expressions 1 and 2.

In the first embodiment, the dimension F of the gap 39 may be greater than 0 mm and less than or equal to 5 mm, preferably be less than or equal to 3 mm, and more preferably be less than or equal to 1 mm. In the first embodiment, the surplus section dimension S1 of the surplus section 22a may preferably be 0.5 to 2 mm, and the inside corner dimension S2 of the first inside corner R1 may preferably be 1 to 2 mm.

In each of the embodiments, the positive electrode active material layers 16 are smaller than the negative electrode active material layers 26, but are not limited to this. When the electrode assembly 23 is viewed in the stacking direction, as long as the positive electrode active material layers 16 are located in the region of the negative electrode active material layers 26, and the entire surfaces of the positive electrode active material layers 16 are opposed to the negative electrode active material layers 26, the positive electrode active material layers 16 may be the same size as the negative electrode active material layers 26.

In the electrode assembly 23 according to each of the embodiments, the insulation between the positive electrodes 14 and the negative electrodes 24 does not necessarily have to be the bag-shaped separators 21, but may be a piece of sheet-like separator located between the positive electrodes 14 and the negative electrode 24 one each. In this case, the surplus section 22a is formed by the section of each separator projecting from the tab-side edge 14a, the bottom-side edge 14b, and the pair of side edges 14c of the positive electrode 14 in the surface direction of the positive electrode 14.

In each of the embodiments, each negative electrode 24 includes the negative electrode active material layers 26 on both sides of the negative electrode metal film 25, but may include the negative electrode active material layer 26 on only one side of the negative electrode metal film 25. Similarly, each positive electrode 14 includes the positive electrode active material layers 16 on both sides of the positive metal foil 15, but may include the positive electrode active material layer 16 on only one side of the positive metal foil 15.

The power storage apparatus does not necessarily have to be applied to the rechargeable battery 10, but may be applied to other power storage apparatuses such as an electric double-layer capacitor.

The rechargeable battery 10 does not necessarily have to be a lithium-ion rechargeable battery, but may be other rechargeable batteries. In short, the rechargeable battery 10 may be any device in which ions move between the positive electrode active material and the negative active material and that gives and receives an electric charge.

A technical idea obtainable from the above embodiments and the modifications is described below.

(1) A power storage apparatus in which the dimension of the electrode assembly in the stacking direction is greater than the dimension between the inner surfaces of the case main body opposed to each other in the stacking direction.

### DESCRIPTION OF THE REFERENCE NUMERALS

F . . . Dimension; S1 . . . Surplus Section Dimension; S2 . . . Inside Corner Dimension; R1 . . . First Inside Corner; R . . . Radius; 10 . . . Power Storage Apparatus, which is Rechargeable Battery; 12 . . . Case Main Body; 12a . . . Bottom Wall; 12d . . . Opening; 12e . . . Inner Bottom Surface; 13 . . . Lid Member; 14 . . . Positive Electrode; 14b, 21b, 24b . . . Bottom-Side Edge; 14c, 21c, 24c . . . Side Edge; 16 . . . Positive Electrode Active Material Layer; 18 . . . Tab Group; 21 . . . Bag-Shaped Separator; 22 . . . Separator Member; 22a . . . Surplus Section; 21f, 24f . . . Corner; 23 . . . Electrode Assembly; 24 . . . Negative Electrode; 26 . . . Negative Electrode Active Material Layer; 37 . . . Bottom Surface; 38 . . . Side Surface; 39 . . . Gap; 44 . . . Flat Surface; 53 . . . Lid Terminal Assembly.

1. A power storage apparatus comprising:
an electrode assembly in which a plurality of negative electrodes each including a negative electrode active material layer and a plurality of positive electrodes each including a positive electrode active material layer are stacked alternately with separators located in between, wherein, as viewed in a stacking direction, the positive electrode active material layer is located in a region of the negative electrode active material layer, and an entire surface of the positive electrode active material layer is opposed to the negative electrode active material layer;
a case main body that accommodates the electrode assembly; and
a lid member that closes an opening of the case main body, wherein
the electrode assembly includes
a bottom surface that is formed by bottom-side edges of the negative electrodes and bottom-side edges of the separators and is opposed to an inner bottom surface of the case main body, and
a pair of side surfaces that are formed by side edges of the negative electrodes and side edges of the separators and are connected to the bottom surface and flat surfaces on opposite ends in the stacking direction,
wherein a bottom-side edge and the side edges of each positive electrode are located inward of the bottom-side edge and the side edges of each negative electrode as viewed in the stacking direction,
the case main body includes a bottom wall that is opposed to the bottom surface of the electrode assembly and forms the inner bottom surface and side walls opposed to the side surfaces,
the power storage apparatus includes an inside corner at an intersection between an inner surface of each side wall and the inner bottom surface of the bottom wall, the inside corner being rounded as viewed in the stacking direction of the electrode assembly,
a direction in which a straight line that is orthogonal to the inner bottom surface of the case main body extends is a depth direction,
a gap exists in the case main body, the gap being formed by separating the bottom surface of the electrode assembly and the inner bottom surface of the case main body from each other in the depth direction, and
the gap includes a dimension in the depth direction that is 1 to 1.5 times a radius of the inside corner.

2. The power storage apparatus according to claim 1, wherein the separators are bag-shaped separators each accommodating one of the positive electrodes.

3. A power storage apparatus comprising:
an electrode assembly in which a plurality of negative electrodes each including a negative electrode active material layer and a plurality of positive electrodes each including a positive electrode active material layer are stacked alternately with separators located in between, wherein, as viewed in a stacking direction, the positive electrode active material layer is located in a region of the negative electrode active material layer, and an entire surface of the positive electrode active material layer is opposed to the negative electrode active material layer;
a case main body that accommodates the electrode assembly; and
a lid member that closes an opening of the case main body, wherein
the electrode assembly includes
a bottom surface that is formed by bottom-side edges of the negative electrodes and bottom-side edges of the separators and is opposed to an inner bottom surface of the case main body, and
a pair of side surfaces that are formed by side edges of the negative electrodes and side edges of the separators and are connected to the bottom surface and flat surfaces on opposite ends in the stacking direction,
wherein a bottom-side edge and the side edges of each positive electrode are located inward of the bottom-side edge and the side edges of each negative electrode as viewed in the stacking direction,
the case main body includes a bottom wall that is opposed to the bottom surface of the electrode assembly and forms the inner bottom surface and side walls opposed to the side surfaces,
the power storage apparatus includes an inside corner at an intersection between an inner surface of each side wall and the inner bottom surface of the bottom wall, the inside corner being rounded as viewed in the stacking direction of the electrode assembly,
a direction in which a straight line that is orthogonal to the inner bottom surface of the case main body extends is a depth direction,
a gap exists in the case main body, the gap being formed by separating the bottom surface of the electrode assembly and the inner bottom surface of the case main body from each other in the depth direction,
the separator includes a surplus section that projects from the bottom-side edge and the side edges of each positive electrode in a surface direction of the separator,
a dimension of the inside corner in the depth direction is referred to as an inside corner dimension,
a dimension of the surplus section in the depth direction is referred to as a surplus section dimension, and
the following expressions are satisfied
the surplus section dimension<the inside corner dimension, and
the dimension of the gap≥the inside corner dimension−the surplus section dimension.

4. The power storage apparatus according to claim 3, wherein
the separators are bag-shaped separators each accommodating one of the positive electrodes, and
a pair of separator members that are opposed to each other with the positive electrode located in between includes sections projecting from the edge of the positive electrode, and the surplus section that projects from the bottom-side edge is formed by welding weldable parts of the projecting sections along the entire length in the depth direction.

5. The power storage apparatus according to claim 3, wherein
the electrode assembly includes
a positive electrode tab group in which positive electrode tabs each projecting from an edge of the positive electrode are stacked, and
a negative electrode tab group in which negative electrode tabs each projecting from an edge of the negative electrode are stacked,
the power storage apparatus includes a lid terminal assembly in which positive and negative electrode terminals secured to the lid member and positive and negative electrode conductive members each joined to the tab group and the electrode terminal of the same polarity are integrated,
the lid terminal assembly and the electrode assembly are integrated by joining each conductive member and the associated tab group of the same polarity, and
the lid member and the case main body are joined with a dimension from an outer surface of the lid member to the bottom surface of the electrode assembly in the depth direction being a minimum value.

6. The power storage apparatus according to claim 5, wherein the positive electrode tab group and the negative electrode tab group are each bent so as to approach each other in the depth direction.

7. The power storage apparatus according to claim 3, wherein
the surplus section dimension is 0.5 to 2 mm,
the inside corner dimension is 1 to 2 mm, and
the dimension of the gap is greater than 0 and less than or equal to 5 mm.

8. The power storage apparatus according to claim 1, wherein the power storage apparatus is a rechargeable battery.

9. A method for manufacturing a power storage apparatus, the power storage apparatus including
an electrode assembly in which a plurality of negative electrodes each including a negative electrode active material layer and a plurality of positive electrodes each including a positive electrode active material layer are stacked alternately with separators located in between, wherein, as viewed in a stacking direction, the positive electrode active material layer is located in a region of the negative electrode active material layer, and an entire surface of the positive electrode active material layer is opposed to the negative electrode active material layer,
a case main body that accommodates the electrode assembly, and
a lid member that closes an opening of the case main body, wherein
the electrode assembly includes
a bottom surface that is formed by bottom-side edges of the negative electrodes and bottom-side edges of the separators and is opposed to an inner bottom surface of the case main body, and
a pair of side surfaces that are formed by side edges of the negative electrodes and side edges of the separators and are connected to the bottom surface and flat surfaces on opposite ends in the stacking direction,
wherein a bottom-side edge and the side edges of each positive electrode are located inward of the bottom-side edge and the side edges of each negative electrode as viewed in the stacking direction,
the case main body includes a bottom wall that is opposed to the bottom surface of the electrode assembly and forms the inner bottom surface and side walls opposed to the side surfaces,
the power storage apparatus includes an inside corner at an intersection between an inner surface of each side wall and the inner bottom surface of the bottom wall, the inside corner being rounded as viewed in the stacking direction of the electrode assembly,
the method comprising:
press-fitting the electrode assembly into the case main body from the bottom surface such that the bottom surface of the electrode assembly and the inner bottom surface of the case main body are spaced apart in a depth direction by a dimension 1 to 1.5 times a radius of the inside corner, the depth direction being a direction in which a straight line that is orthogonal to the inner bottom surface of the case main body extends.

10. A method for manufacturing a power storage apparatus, the power storage apparatus including an electrode assembly in which a plurality of negative electrodes each including a negative electrode active material layer and a plurality of positive electrodes each including a positive electrode active material layer are stacked alternately with separators located in between, wherein, as viewed in a stacking direction, the positive electrode active material layer is located in a region of the negative electrode active material layer, and an entire surface of the positive electrode active material layer is opposed to the negative electrode active material layer, the electrode assembly including a positive electrode tab group in which positive electrode tabs each projecting from an edge of the positive electrode are stacked and a negative electrode tab group in which negative electrode tabs each projecting from an edge of the negative electrode are stacked,
a case main body that accommodates the electrode assembly,
a lid member that closes an opening of the case main body,
positive and negative electrode terminals secured to the lid member, and
positive and negative electrode conductive members each joined to the tab group and the electrode terminal of the same polarity, wherein
the electrode assembly includes
a bottom surface that is formed by bottom-side edges of the negative electrodes and bottom-side edges of the separators and is opposed to an inner bottom surface of the case main body, and
a pair of side surfaces that are formed by side edges of the negative electrodes and side edges of the separators and are connected to the bottom surface and flat surfaces on opposite ends in the stacking direction,
wherein a bottom-side edge and the side edges of each positive electrode are located inward of the bottom-side edge and the side edges of each negative electrode as viewed in the stacking direction,
the case main body includes a bottom wall that is opposed to the bottom surface of the electrode assembly and forms the inner bottom surface and side walls opposed to the side surfaces,
the power storage apparatus includes an inside corner at an intersection between an inner surface of each side wall and the inner bottom surface of the bottom wall, the inside corner being rounded as viewed in the stacking direction of the electrode assembly,
a direction in which a straight line that is orthogonal to the inner bottom surface of the case main body extends is referred to as a depth direction,
the power storage apparatus includes a gap in the case main body, the gap being formed by separating the bottom surface of the electrode assembly and the inner bottom surface of the case main body from each other in the depth direction,
the separator includes a surplus section that projects from the bottom-side edge and the side edges of each positive electrode in a surface direction of the separator,
a dimension of the inside corner in the depth direction is referred to as an inside corner dimension,
a dimension of the surplus section in the depth direction is referred to as a surplus section dimension, the method comprising:
manufacturing a lid terminal assembly in which the lid member, the positive and negative electrode terminals, and the positive and negative electrode conductive members are integrated;
joining each conductive member and the associated tab group of the same polarity to integrate the lid terminal assembly and the electrode assembly;
press-fitting the electrode assembly into the case main body such that even if force is applied in the depth direction, a dimension from an outer surface of the lid member to the bottom surface of the electrode assembly in the depth direction stays at a minimum value; and
press-fitting the electrode assembly into the case main body until the following expressions are satisfied:
the surplus section dimension<the inside corner dimension, and
the dimension of the gap≥the inside corner dimension−the surplus section dimension.

11. The power storage apparatus according to claim 3, wherein the power storage apparatus is a rechargeable battery.
